(19) United States
(12) Patent Application Publication
(10) Pub. No.: US 2026/0179524 A1
(43) Pub. Date: Jun. 25, 2026

(54) Display Device

(71) Applicant: LG Display Co., Ltd., Seoul (KR)

(72) Inventor: Taehwan Kim, Daegu (KR)

(21) Appl. No.: 19/293,775

(22) Filed: Aug. 7, 2025

(30) Foreign Application Priority Data
Dec. 20, 2024 (KR) 10-2024-0193003

(51) Int. Cl. G09G 3/20; G09G 3/3233

(52) U.S. Cl. CPC G09G 3/2092; G09G 3/2007; G09G 3/3233; G09G 2300/0842; G09G 2300/0861; G09G 2310/0297; G09G 2310/08; G09G 2320/068; G09G 2380/10

(57) ABSTRACT

A display device includes a timing controller which generates image data based on an input image, a data driver which generates a data signal based on the image data and outputs the data signal to a data line and a display panel which includes a pixel connected to the data line, wherein the timing controller generates a first image and a second image based on the input image, generates a third image by adjusting a gray scale of at least a partial area of the first image, and generates image data corresponding to the second image and the third image.

### CROSS-REFERENCE TO RELATED APPLICATION

This application claims the priority of Republic of Korea Patent Application No. 10-2024-0193003 filed on December 20, 2024, which is hereby incorporated by reference in its entirety.

### FIELD

The present disclosure relates to an apparatus and particularly to, for example, without limitation, a display device, and more particularly to a display device in which a viewing angle is controllable.

### DESCRIPTION OF THE RELATED ART

As the technology in modern society develops, display devices are used in various ways to provide information to users. The display devices include not only electronic signs which simply transmit visual information in one direction, but also various electronic devices which require higher level of technology to check a user’s input and provide information in response to the checked input.

For example, a display device is included in a vehicle to provide various information to a driver and passengers of the vehicle.

### SUMMARY

The inventors of the present disclosure have recognized that the display device of the vehicle needs to appropriately display content without interrupting the operation of the vehicle. For example, the display device needs to limit the display of the content which may reduce the concentration on the driving while the vehicle is in operation.

An object to be achieved by the present disclosure is to provide a display device with an improved quality of display images.

Another object to be achieved by the present disclosure is to provide a display device which provides an image at a wide viewing angle or a narrow viewing angle depending on a driving mode.

Objects of the present disclosure are not limited to the above-mentioned objects, and other objects, which are not mentioned above, can be clearly understood by those skilled in the art from the following descriptions.

According to an embodiment of the present disclosure, a display device includes a timing controller which generates image data based on an input image, a data driver which generates a data signal based on the image data and outputs the data signal to a data line and a display panel which includes a pixel connected to the data line, wherein the timing controller generates a first image and a second image based on the input image, generates a third image by adjusting a gray scale of at least a partial area of the first image, and generates image data corresponding to the second image and the third image.

According to another embodiment of the present disclosure, a display device includes a timing controller which generates a second image and a third image based on an input image and generates image data based on the second image and the third image, a data driver which generates a first data signal based on image data corresponding to the second image, generates a second data signal based on image data corresponding to the third image, and outputs the first data signal and the second data signal to the data line and a display panel which includes a pixel connected to the data line, wherein the timing controller generates a first MUX (multiplexer) signal for controlling a timing when the first data signal is output and a second MUX signal for controlling a timing when the second data signal is output and a width of a period in which the first MUX signal has a turn-on level is smaller than a width of a period in which the second MUX signal has a turn-on level.

Other detailed matters of the exemplary embodiments are included in the detailed description and the drawings.

According to the present disclosure, an input image is separated into two images to be provided at different viewing angles and then image data is generated by adjusting a gray scale of at least a partial area of one image of two images.

Accordingly, a continuity of an image which is recognized by a user who watches the image in a position where a viewing angle is limited is ensured to improve a quality of the display image.

The effects according to the present disclosure are not limited to the contents exemplified above, and more various effects are included in the present specification.

It is to be understood that both the foregoing general description and the following detailed description are exemplary and explanatory and are intended to provide further explanation of the inventive concepts as claimed.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exemplary view of a display device according to an exemplary embodiment of the present disclosure;

FIG. 2 is a block diagram of a display device according to an exemplary embodiment of the present disclosure;

FIG. 3 is a view illustrating an example of a display panel included in a display device of FIG. 2 according to an exemplary embodiment of the present disclosure;

FIG. 4 is a circuit diagram illustrating an example of a pixel included in a display device of FIG. 2 according to an exemplary embodiment of the present disclosure;

FIG. 5 is a view illustrating an example of a first optical member disposed on a first light emitting diode included in a pixel of FIG. 4 according to an exemplary embodiment of the present disclosure;

FIG. 6 is a view illustrating an example of a second optical member disposed on a second light emitting diode included in a pixel of FIG. 4 according to an exemplary embodiment of the present disclosure;

FIG. 7 is a block diagram illustrating an example of a data driver included in a display device of FIG. 2 according to an exemplary embodiment of the present disclosure;

FIG. 8 is a block diagram illustrating an example of a timing controller included in a display device of FIG. 2 according to an exemplary embodiment of the present disclosure;

FIGS. 9A to 9E are views for explaining an example of an operation of a timing controller of FIG. 8 according to an exemplary embodiment of the present disclosure;

FIG. 10 is a waveform chart for explaining an example of an operation of a MUX signal generating unit included in a timing controller of FIG. 8 according to an exemplary embodiment of the present disclosure; and

FIG. 11 is a waveform chart for explaining another example of an operation of a MUX signal generating unit included in a timing controller of FIG. 8 according to an exemplary embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure. Therefore, the present disclosure will be defined only by the scope of the appended claims.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted or may be briefly provided to avoid unnecessarily obscuring the subject matter of the present disclosure. The terms such as “including,” “having,” and “comprising” used herein are generally intended to allow other components to be added unless the terms are used with the term “only”. Any references to singular may include plural unless expressly stated otherwise.

Any implementation described herein as an “example” is not necessarily to be construed as preferred or advantageous over other implementations.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

In describing a temporal relationship, when the temporal order is described as, for example, “after,” “subsequent,” “next,” and “before,” a case that is not continuous may be included unless a more limiting term, such as “just,” “immediate(ly),” or “direct(ly)” is used.

In describing components of the exemplary embodiment of the present disclosure, terminologies such as first, second, A, B, (a), (b), and the like may be used. These terminologies are used to distinguish a component from the other component, but a nature, an order, or the number of the components is not limited by the terminology. When a component is “linked”, “coupled”, or “connected” to another component, the component may be directly linked or connected to the other component. However, unless specifically stated otherwise, it should be understood that a third component may be interposed between the components which may be indirectly linked or connected.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

When the position relation between two parts is described using the terms such as “on”, “above”, “below”, and “next”, one or more parts may be positioned between the two parts unless the terms are used with the term “immediately” or “directly”.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

The features of various embodiments of the present disclosure can be partially or entirely adhered to or combined with each other and can be interlocked and operated in technically various ways, and the embodiments can be carried out independently of or in association with each other.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure.

The following embodiments will be described focusing on the organic light emitting display device. However, embodiments of the present specification are not limited to organic light emitting display devices and can be applied to various electroluminescent displays. For example, the electroluminescent display apparatus may use an organic light emitting diode (OLED) display apparatus, a quantum dot light emitting diode display apparatus, or an inorganic light emitting diode display apparatus.

Hereinafter, exemplary embodiments of the present disclosure will be described in detail with reference to accompanying drawings.

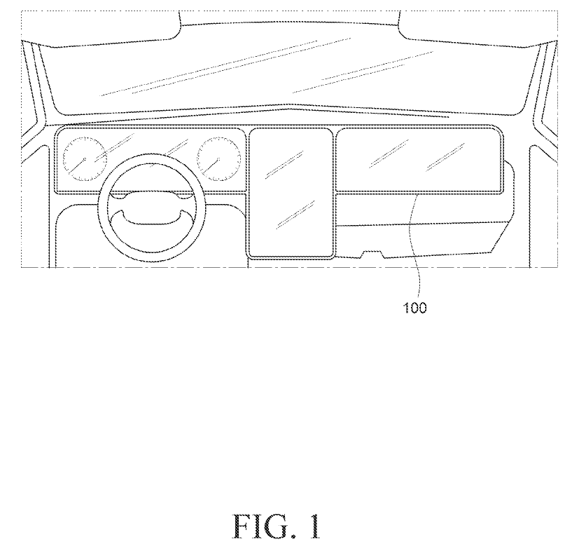

FIG. 1 is an exemplary view of a display device according to an exemplary embodiment of the present disclosure.

Referring to FIG. 1, the display device 100 may be disposed in at least a part of a dashboard of a vehicle. The dashboard of the vehicle may include a configuration disposed in a front surface of front seats (for example, a driver seat and a front passenger seat) of the vehicle. For example, on the dashboard of the vehicle, an input configuration for manipulating various functions (for example, an air-conditioner, an audio system, or a navigation system) in the vehicle may be disposed.

The display device 100 is disposed on the dashboard of the vehicle to operate as an input unit which manipulates at least a part of various functions of the vehicle. The display device 100 may provide various information related to the vehicle, for example, operation information of the vehicle (for example, a current speed of the vehicle, a remaining fuel amount, or a mileage) or information about parts of the vehicle (for example, a damage level of a vehicle tire).

The display device 100 may be disposed across the driver seat and the front passenger seat disposed in the front seats of the vehicle. A user of the display device 100 may include a driver of the vehicle and a passenger riding on the front passenger seat. Both the vehicle driver and the passenger may use the display device 100.

Only a part of the display device 100 may be illustrated in FIG. 1. The display device 100 illustrated in FIG. 1 may represent a display panel, among various configurations included in the display device 100. Specifically, for example, the display device 100 illustrated in FIG. 1 may represent at least a part of an active area and a non-active area of the display panel. Among the configurations of the display device 100, configurations other than the parts illustrated in FIG. 1 may be mounted inside the vehicle (or at least a part of the inside of the vehicle).

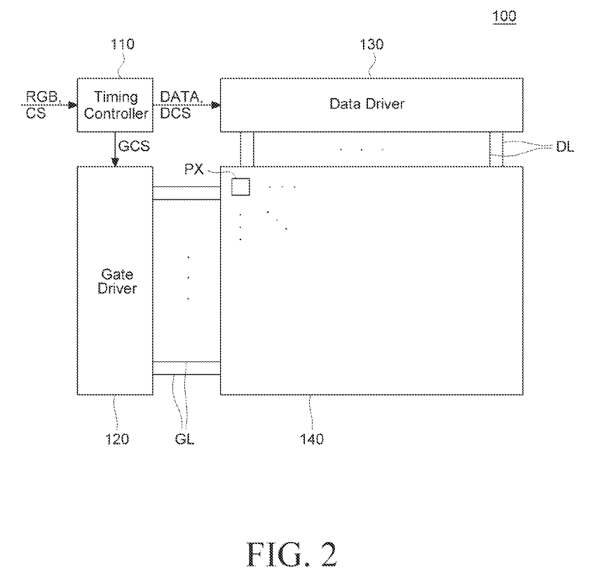

FIG. 2 is a block diagram of a display device according to an exemplary embodiment of the present disclosure.

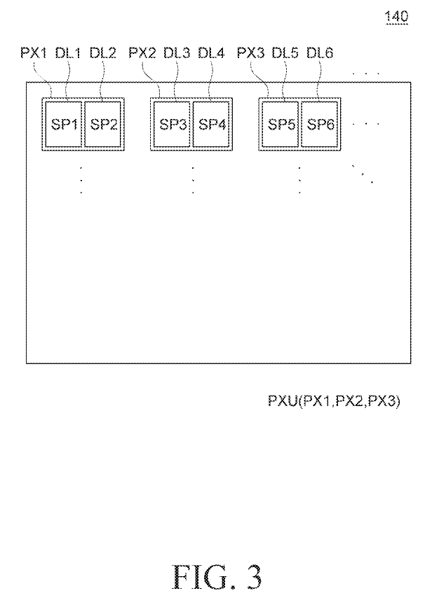

FIG. 3 is a view illustrating an example of a display panel included in a display device of FIG. 2 according to an exemplary embodiment of the present disclosure.

Referring to FIG. 2, a display device 100 according to an exemplary embodiment of the present disclosure may include a timing controller 110, a gate driver 120, a data driver 130, and a display panel 140.

The display panel 140 may generate images to be provided to the user. For example, the display panel 140 may include a plurality of pixels PX in which pixel circuits are disposed, respectively. Each of the plurality of pixels PX is connected to a corresponding gate line GL and a corresponding data line DL to display images in response to a gate signal supplied to the gate line GL and a data signal supplied to the data line DL.

For example, further referring to FIG. 3, at least some of the plurality of pixels PX disposed in the display panel 140 may form one unit pixel PXU. For example, three pixels PX which emit different color light, for example, a first pixel PX1, a second pixel PX2, and a third pixel PX3 may form one unit pixel PXU.

The first pixel PX1, the second pixel PX2, and the third pixel PX3 included in one unit pixel PXU emit different color light. For example, the first pixel PX1 may emit light with a first color, for example, red, the second pixel PX2 may emit light with a second color, for example, green, and the third pixel PX3 may emit light with a third color, for example, blue. Accordingly, the first pixel may be referred to as a red pixel, the second pixel PX2 may be referred to as a green pixel, and the third pixel PX3 may be referred to as a blue pixel. However, it is not limited thereto, and in some cases, one unit pixel PXU may further include a sub pixel for further implementing a specific color, for example, white.

In one exemplary embodiment each of the first pixel PX1, the second pixel PX2, and the third pixel PX3 includes two sub pixels. For example, the first pixel PX1 may include a first sub pixel SP1 and a second sub pixel SP2, the second pixel PX2 may include a third sub pixel SP3 and a fourth sub pixel SP4, and the third pixel PX3 may include a fifth sub pixel SP5 and a sixth sub pixel SP6.

Here, two sub pixels included in one pixel may include a pixel circuit structure which is substantially the same or similar. For example, each of the plurality of pixels PX, for example, each of the first pixel PX1, the second pixel PX2, and the third pixel PX3 may include a first pixel circuit and a second pixel circuit.

Further, the plurality of pixels PX, for example, each of the first pixel PX1, the second pixel PX2, and the third pixel PX3 may be connected two corresponding data lines DL. For example, each of two sub pixels included in one pixel may be connected to a corresponding data line DL. For example, the first sub pixel SP1 and the second sub pixel SP2 included in the first pixel PX1 are connected to a first data line DL1 and a second data line DL2, respectively to be supplied with a data signal. The third sub pixel SP3 and the fourth sub pixel SP4 included in the second pixel PX2 are connected to a third data line DL3 and a fourth data line DL4, respectively to be supplied with a data signal. The fifth sub pixel SP5 and the sixth sub pixel SP6 included in the third pixel PX3 are connected to a fifth data line DL5 and a sixth data line DL6, respectively to be supplied with a data signal.

Further, two sub pixels included in one pixel may include a first light emitting diode and a second light emitting diode which emit the same color light. For example, the first pixel circuit included in one pixel is connected to the first light emitting diode to allow the first light emitting diode to emit light and the second pixel circuit is connected to the second light emitting diode to allow the second light emitting diode to emit light.

Here, one pixel may include a first optical member which refracts light from the first light emitting diode to a specific direction and a second optical member which refracts light from the second light emitting diode to a specific direction. For example, the first optical member and the second optical member are implemented as lenses, but the exemplary embodiment of the present disclosure is not limited thereto.

For example, the first optical member may be disposed in an optical area in which light is provided in a first range to form a first viewing angle and the second optical member may be disposed in an optical area in which light is provided in a second range to form a second viewing angle. The first range may be larger than the second range. Therefore, the first optical member and the second optical member may control a viewing angle of each of the plurality of pixels PX, for example, the first pixel PX1, the second pixel PX2, and the third pixel PX3.

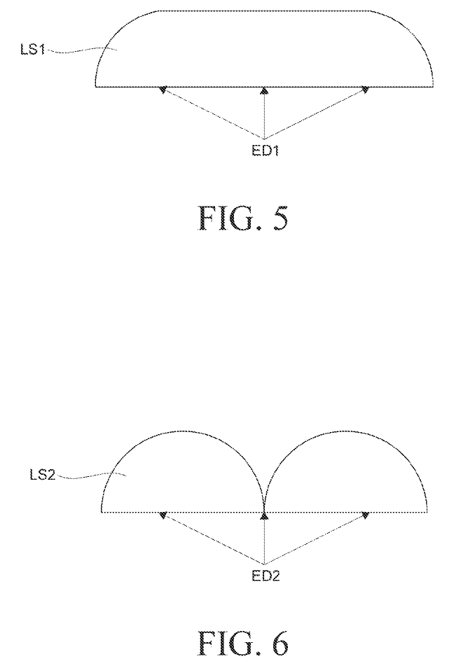

The first optical member and the second optical member will be described in detail below with reference to FIGS. 5 and 6.

Referring to FIG. 2 again, the timing controller 110 may control the gate driver 120 and the data driver 130 based on input image RGB and an input control signal CS supplied from the outside, for example, a host system. For example, the input control signal CS may include timing signals, such as a horizontal synchronization signal, a vertical synchronization signal, a data enable signal, and a clock signal and the timing controller 110 may generate a gate control signal GCS and a data control signal DCS based on the input control signal CS. The gate control signal GCS may be supplied to the gate driver 120 and the data control signal DCS may be supplied to the data driver 130.

Further, the timing controller 110 may realign an input image RGB with a digital video data format in accordance with a resolution of the display panel 140 to generate image data DATA and provide the image data to the data driver 130.

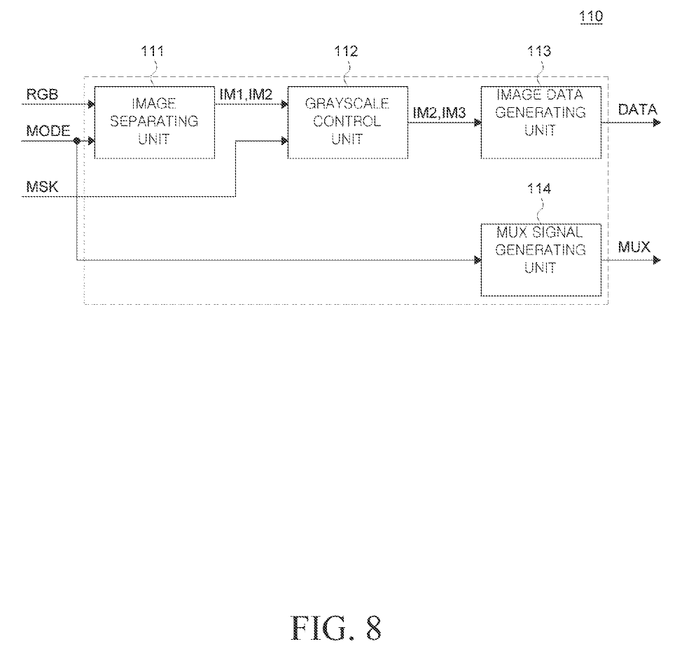

In the exemplary embodiment, the input control signal CS supplied from the timing controller 110 further may include a mode signal and masking information. The timing controller 110 may adjust image data DATA and/or a pulse width of a MUX signal, based on the mode signal and the masking information. This will be described in more detail with reference to FIGS. 8 to 11.

The gate driver 120 may generate a gate signal based on the gate control signal GCS and may output the gate signal to the plurality of gate lines GL. For example, the gate driver 120 sequentially may output the gate signal to the plurality of gate lines GL in the unit of horizontal lines.

The data driver 130 may convert digital type image data DATA supplied from the timing controller 110 into an analog type data signal based on the data control signal DCS to supply the converted analog data signal to the plurality of data lines DL.

For example, the data driver 130 may latch image data DATA in accordance with the data control signal DCS to convert the image data into an analog type data signal (data voltage) and then supply the data signal to the plurality of data lines DL. For example, the data control signal DCA may include a line latch signal.

According to an exemplary embodiment, when the display panel 140 is used for the vehicle which has been described with reference to FIG. 1, a field of view of at least a part of an image displayed on the display panel 140 needs to be restricted according to the driving mode. For example, contents regarding an entertainment function and seat information for the passenger sitting on the front passenger seat among contents included in an image displayed on the display panel 140, may interrupt the driving of the driver. Accordingly, according to the user’s request or a driving mode, a field of view of the contents needs to be restricted.

Accordingly, in order to restrict a field of view of at least some contents included in the display image, data signals supplied to two sub pixels included in each of the plurality of pixels may correspond to data signals corresponding to different images. For example, the timing controller 110 splits one input image RGB into two images, for example, two images to be provided at a first range of viewing angle and a second range of viewing angle, and then may generate image data corresponding to two images. Accordingly, different data signals which are generated based on image data corresponding to two individual images may be provided to two sub pixels included in each of the plurality of pixels PX.

Specifically, a first data signal corresponding to an image which is provided in a first range may be provided to the first pixel circuit included in each of the plurality of pixels PX and a second data signal corresponding to an image which is provided in a second range may be provided to the second pixel circuit. Accordingly, the first data signal and the second data signal may be time-divided to be supplied to each of the plurality of pixels PX.

In this case, light emitted from the first light emitting diode connected to the first pixel circuit is provided through the first optical member in the first range so that an image displayed by the corresponding light, that is, an image corresponding to the first data signal may form a first viewing angle, for example, a wide viewing angle. Further, light emitted from the second light emitting diode connected to the second pixel circuit is provided through the second optical member in the second range so that an image displayed by the corresponding light, for example, an image corresponding to the second data signal may form a second viewing angle, for example, a narrow viewing angle. Here, as the pixel circuit is driven, the first light emitting diode and the second light emitting diode simultaneously emit light so that an image corresponding to the first data signal and an image corresponding to the second data signal may be simultaneously displayed.

At this time, in a position where both the image in the first range and the image in the second range are visible, such as a position of a passenger, the user may visually recognize both an image displayed according to the first data signal and an image displayed according to the second data signal. For example, the user visually recognizes an image in which an image displayed according to the first data signal and an image displayed according to the second data signal overlap. Accordingly, the user may watch the entire image including an image corresponding to a content whose viewing angle needs to be restricted, for example, an image corresponding to the second data signal.

In contrast, in a position where the image in the first range is visible, but the image in the second range is not visible due to the viewing angle of the image in the second range, such as a position of the driver, the user may recognize an image which is displayed according to the first data signal, but does not recognize an image displayed according to the second data signal. Accordingly, the user may not watch an image corresponding to the content whose viewing angle needs to be restricted, for example, an image corresponding to the second data signal, but may watch only an image excluding the image, for example, an image corresponding to the first data signal.

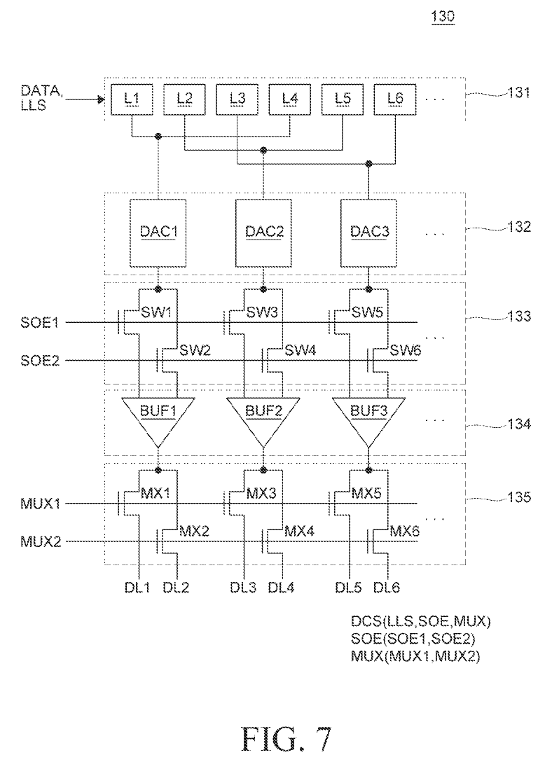

This will be described in more detail below with reference to FIGS. 7 to 11.

In the meantime, in the above description, it has been described that different data signals are supplied to the first pixel circuit and the second pixel circuit included in each of the plurality of pixels PX, but the present disclosure is not limited thereto. For example, the same data signal may be supplied to the first pixel circuit and the second pixel circuit included in each of the plurality of pixels PX according to the driving mode.

Further, in the above description, it has been described that both the first light emitting diode and the second light emitting diode included in each of the plurality of pixels PX emit light, but the present disclosure is not limited thereto. For example, only one of the first light emitting diode and the second light emitting diode emits light according to a driving mode.

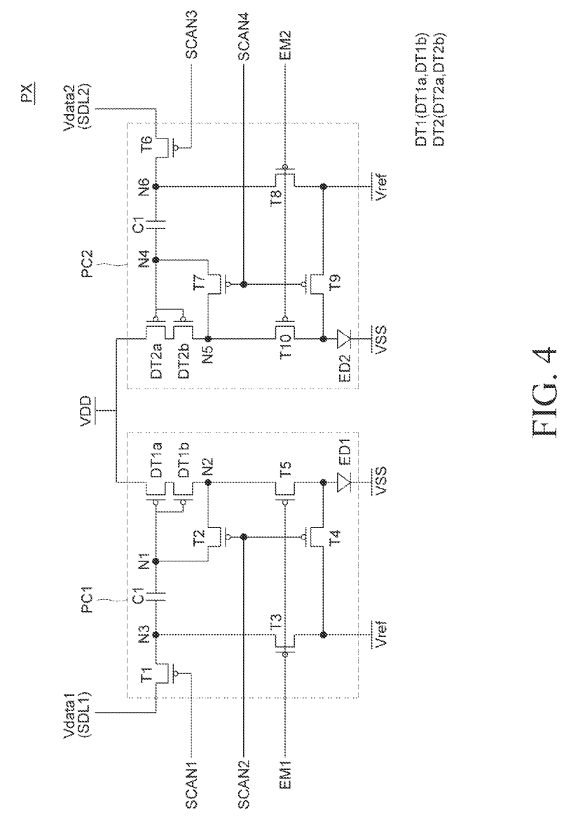

FIG. 4 is a circuit diagram illustrating an example of a pixel included in a display device of FIG. 2 according to an exemplary embodiment of the present disclosure.

Referring to FIG. 4, the pixel PX may include a first pixel circuit PC1 and a second pixel circuit PC2. For example, the first pixel circuit PC1 may be a pixel circuit which allows the first light emitting diode ED1 to emit light and the second pixel circuit PC2 may be a pixel circuit which allows the second light emitting diode ED2 to emit light. In the exemplary embodiment, the first pixel circuit PC1 and the second pixel circuit PC2 may have substantially the same or substantially same pixel circuit structure.

The first pixel circuit PC1 may include a first driving transistor DT1, a plurality of transistors T1 to T5, a first capacitor C1, and a first light emitting diode ED1.

The first driving transistor DT1 may be connected between a high potential power line which supplies a high potential power voltage VDD and a low potential power line which supplies a low potential power voltage VSS. The first driving transistor DT1 may control a first driving current applied to the first light emitting diode ED1 in accordance with a source-gate voltage. For example, the first driving transistor DT1 may control the first driving current which flows from the high potential power line to the low potential power line via the first light emitting diode ED1 in response to a voltage of a first node N1 which is a gate electrode. To this end, the high potential power voltage VDD may be set to be higher than the low potential power voltage VSS. For example, the high potential power voltage VDD may be a positive voltage and the low potential power voltage VSS may be a negative voltage.

According to an exemplary embodiment, the first driving transistor DT1 may include first and second sub driving transistors DT1a and DT1b which are connected in series. Each of the first and second sub driving transistors DT1a and DT1b may include a gate electrode which is commonly connected to the first node N1. For example, the first driving transistor DT1 may have a dual gate structure.

A first transistor T1 may be connected between the first sub data line SDL1 which supplies the first data signal Vdata1 and a third node N3. The first transistor T1 may include a gate electrode connected to the first scan signal line to which the first scan signal SCAN1 is applied to be turned on or turned off by the first scan signal SCAN1. For example, the first transistor T1 may supply the first data signal Vdata1 to the third node N3 in response to a low level of first scan signal SCAN1 which is a turn-on level.

A second transistor T2 may be connected between the gate electrode and the drain electrode of the first driving transistor DT1, for example, between the first node N1 and a second node N2. The second transistor T2 may include a gate electrode connected to the second scan signal line to which the second scan signal SCAN2 is applied to be turned on or turned off by the second scan signal SCAN2. For example, the second transistor T2 may diode-connect the gate electrode and the drain electrode of the first driving transistor DT1 in response to a low level of second scan signal SCAN2 which is a turn-on level.

A third transistor T3 may be connected between a third node N3 and a reference voltage line which supplies a reference voltage Vref. The third transistor T3 may include a gate electrode connected to the first emission signal line to which a first emission control signal EM1 is applied to be turned on or turned off by the first emission control signal EM1. For example, the third transistor T3 may apply the reference voltage Vref to the third node N3 in response to a low level of first emission control signal EM1 which is a turn-on level.

A fourth transistor T4 may be connected between the first electrode of the first light emitting diode ED1, for example, an anode electrode and the reference voltage line. The fourth transistor T4 may include a gate electrode connected to the second scan signal line to which the second scan signal SCAN2 is applied to be turned on or turned off by the second scan signal SCAN2. For example, the fourth transistor T4 may apply the reference voltage Vref to the first electrode of the first light emitting diode ED1 in response to the low level of second scan signal SCAN2 which is a turn-on level.

A fifth transistor T5 may be connected between the second node N2 and the first electrode of the first light emitting diode ED1. The fifth transistor T5 may include a gate electrode connected to the first emission signal line to which a first emission control signal EM1 is applied to be turned on or turned off by the first emission control signal EM1. When the fifth transistor T5 is turned on, the second node N2 may be electrically connected to the first light emitting diode ED1 to form a current path between the first driving transistor DT1 and the first light emitting diode ED1.

The first capacitor C1 may be connected between the first node N1 and the third node N3. For example, the first capacitor C1 may include a first electrode connected to the first node N1 and a second electrode connected to the third node N3. The first capacitor C1 may store a predetermined voltage to constantly maintain a voltage of the gate electrode of the first driving transistor DT1 while the first light emitting diode ED1 emits light.

The second pixel circuit PC2 may include a second driving transistor DT2, a plurality of transistors T6 to T10, a second capacitor C2, and a second light emitting diode ED2.

The second driving transistor DT2 may be connected between the high potential power line and the low potential power line. The second driving transistor DT2 may control a second driving current applied to the second light emitting diode ED2 in accordance with a source-gate voltage. For example, the second driving transistor DT2 may control the second driving current which flows from the high potential power line to the low potential power line via the second light emitting diode ED2 in response to a voltage of a fourth node N4 which is a gate electrode.

According to an exemplary embodiment, the second driving transistor DT2 may include third and fourth sub driving transistors DT2a and DT2b which are connected in series. Each of the third and fourth sub driving transistors DT2a and DT2b may include a gate electrode which is commonly connected to the fourth node N4. For example, the second driving transistor DT2 may have a dual gate structure.

A sixth transistor T6 may be connected between the second sub data line SDL2 which supplies the second data signal Vdata2 and a sixth node N6. The sixth transistor T6 may include a gate electrode connected to the third scan signal line to which the third scan signal SCAN3 is applied to be turned on or turned off by the third scan signal SCAN3. For example, the sixth transistor T6 may supply the second data signal Vdata2 to the sixth node N6 in response to a low level of third scan signal SCAN3 which is a turn-on level.

A seventh transistor T7 may be connected between the gate electrode and the drain electrode of the second driving transistor DT2, for example, between the fourth node N4 and a fifth node N5. The seventh transistor T7 may include a gate electrode connected to the fourth scan signal line to which the fourth scan signal SCAN4 is applied to be turned on or turned off by the fourth scan signal SCAN4. For example, the seventh transistor T7 may diode-connect the gate electrode and the drain electrode of the second driving transistor DT2 in response to a low level of fourth scan signal SCAN4 which is a turn-on level.

An eighth transistor T8 may be connected between the sixth node N6 and the reference voltage line. The eighth transistor T8 may include a gate electrode connected to the second emission signal line to which a second emission control signal EM2 is applied to be turned on or turned off by the second emission control signal EM2. For example, the eighth transistor T8 may apply the reference voltage Vref to the sixth node N6 in response to a low level of second emission control signal EM2 which is a turn-on level.

A ninth transistor T9 may be connected between the first electrode of the second light emitting diode ED2, for example, an anode electrode and the reference voltage line. The ninth transistor T9 may include a gate electrode connected to the fourth scan signal line to which the fourth scan signal SCAN4 is applied to be turned on or turned off by the fourth scan signal SCAN4. For example, the ninth transistor T9 may apply the reference voltage Vref to the first electrode of the second light emitting diode ED2 in response to the low level of fourth scan signal SCAN4 which is a turn-on level.

A tenth transistor T10 may be connected between the fifth node N5 and the first electrode of the second light emitting diode ED2. The tenth transistor T10 may include a gate electrode connected to the second emission signal line to which a second emission control signal EM2 is applied to be turned on or turned off by the second emission control signal EM2. When the tenth transistor T10 is turned on, the fifth node N5 may be electrically connected to the second light emitting diode ED2 to form a current path between the second driving transistor DT2 and the second light emitting diode ED2.

The second capacitor C2 may be connected between the fourth node N4 and the sixth node N6. For example, the second capacitor C2 may include a first electrode connected to the fourth node N4 and a second electrode connected to the sixth node N6. The second capacitor C2 may store a predetermined voltage to constantly maintain a voltage of the gate electrode of the second driving transistor DT2 while the second light emitting diode ED2 emits light.

According to an exemplary embodiment, the first data signal Vdata1 supplied to the first sub data line SDL1 and the second data signal Vdata2 supplied to the second sub data line SDL2 may be a data signal corresponding to an image in the first range and a data signal corresponding to an image in the second range, which have been described with reference to FIG. 2. For example, an image displayed by light emitted from the first light emitting diode ED1 based on the first data signal Vdata1 applied to the first pixel circuit PC1 may have a first range of viewing angle. An image displayed by light emitted from the second light emitting diode ED2 based on the second data signal Vdata2 applied to the second pixel circuit PC2 may have a second range of viewing angle.

In the meantime, according to the exemplary embodiment, the first scan signal SCAN1 and the third scan signal SCAN3 may be the same signal and the second scan signal SCAN2 and the fourth scan signal SCAN4 may be the same signal. For example, the first scan signal line and the third scan signal line may be the same signal line and the second scan signal line and the fourth scan signal line may be the same signal line.

Further, the first emission control signal EM1 and the second emission control signal EM2 may be the same signal. For example, the first emission signal line and the second emission signal line may be the same signal line.

That is, as described above, the first pixel circuit PC1 and the second pixel circuit PC2 may have the same or substantially same pixel circuit structure and are applied with the same signal, excluding the data signal, to be controlled according to the same timing. Accordingly, the first light emitting diode ED1 included in the first pixel circuit PC1 and the second light emitting diode ED2 included in the second pixel circuit PC2 may emit the light in the same period.

However, this is just illustrative so that the first scan signal line and the third scan signal line may be different signal lines and the second scan signal line and the fourth scan signal line may be different signal lines, and/or the first emission signal line and the second emission signal line may be different signal lines.

FIG. 5 is a view illustrating an example of a first optical member disposed on a first light emitting diode included in a pixel of FIG. 4 according to an exemplary embodiment of the present disclosure.

FIG. 6 is a view illustrating an example of a second optical member disposed on a second light emitting diode included in a pixel of FIG. 4 according to an exemplary embodiment of the present disclosure.

Referring to FIGS. 4, 5, and FIG. 6, a first optical member LS1 may be disposed above the first light emitting diode ED1 of the first pixel circuit PC1 included in one pixel PX and a second optical member LS2 may be disposed above the second light emitting diode ED2 of the second pixel circuit PC2 included in one pixel PX. In the meantime, as described with reference to FIG. 2, the first light emitting diode ED1 and the second light emitting diode ED2 included in one pixel PX may emit the same color light.

Referring to FIG. 5, the first optical member LS1 may be disposed on the first light emitting diode ED1. Light generated by the first light emitting diode ED1 in each pixel PX may be emitted through the first optical member LS1 of the corresponding pixel PX. The first optical member LS1 may have a shape that does not limit light of at least one direction. For example, a planar shape of the first optical member LS1 located in each pixel PX may have a bar shape extending in one direction.

In this case, a traveling direction of the light emitted from the first optical member LS1 of each pixel PX may not be restricted to one direction. For example, content (or images) provided through the first optical member LS1 of the pixel PX may be shared by surrounding people who is adjacent to the user in one direction. Accordingly, the content provided by the light emitted through the first optical member LS1 may be provided in a first viewing angle range which is larger than a viewing angle of content provided by the light emitted through the second optical member LS2. For example, the content provided by the light emitted through the first optical member LS1 may be provided in a wide field-of-view (share view).

The second optical member LS2 may be disposed on the second light emitting diode ED2. Light generated by the second light emitting diode ED2 in each pixel PX may be emitted through the second optical member LS2 of the corresponding pixel PX. The second optical member LS2 may restrict a traveling direction of passing light in one direction and/or the other direction. For example, a planar shape of the second optical member LS2 located in each pixel PX may be a circle.

In this case, a traveling direction of the light emitted from the second optical member LS2 of each pixel PX may be restricted to one direction and/or the other direction. For example, contents (or images) provided through the second optical member LS2 of each pixel PX may not be shared by surrounding people of the user. Accordingly, the content provided by the light emitted through the second optical member LS2 may be provided in a second viewing angle range which is smaller than (e.g., less than) a viewing angle of contents provided by the light emitted through the first optical member LS1. For example, the content provided by the light emitted through the second optical member LS2 may be provided in a narrow field-of-view (private view).

FIG. 7 is a block diagram illustrating an example of a data driver included in a display device of FIG. 2 according to an exemplary embodiment of the present disclosure.

Referring to FIGS. 2, 3 and 7, the data driver 130 may include a latch unit 131 (e.g., a circuit), a digital-to-analog converting unit 132 (e.g., a circuit), a switching unit 133 (e.g., a circuit), and a buffer unit 134 (e.g., a circuit).

The latch unit 131 samples and latches digital type image data DATA supplied from the timing controller 110 and simultaneously outputs the latched data in response to a line latch signal LLS included in the data control signal DCS to provide the latched digital type image data DATA to the digital-to-analog converting unit 132. For example, when the display panel 140 includes n (n is an integer which is larger than 0) data lines DL, the latch unit 131 includes n latches and each latch may latch image data DATA for one pixel. In the meantime, in FIG. 7, six latches (L1 to L6) among n latches included in the latch unit 131 are illustrated.

The digital-to-analog converting unit 132 may convert the digital type image data DATA supplied from the latch unit 131 into an analog type data signal (data voltage). For example, the digital-to-analog converting unit 132 may include a half of the number of latches included in the latch unit 131, for example, (n/2) digital analog converters DAC. In the meantime, in FIG. 7, three digital analog converters DAC1 to DAC3, among n/2 digital analog converters included in the digital-to-analog converting unit 132, are illustrated.

In one exemplary embodiment, each of digital analog converters DAC1 to DAC3 included in the digital-to-analog converting unit 132 is connected to two laches to be provided with image data DATA output from two latches in a time division manner and may generate and output the analog type data signal (data voltage) based on the image data. For example, a first digital analog converter DAC1 may be provided with image data DATA from a first latch L1 and a fourth latch L4 in a time division manner. A second digital analog converter DAC2 may be provided with image data DATA from a second latch L2 and a fifth latch L5 in a time division manner. A third digital analog converter DAC3 may be provided with image data DATA from a third latch L3 and a sixth latch L6 in a time division manner.

For example, image data DATA provided from the first latch L1 and the fourth latch L4 are image data corresponding to a data signal supplied to one pixel PX, for example, a first pixel PX1 of FIG. 3 and may correspond to a data signal supplied to each of the first sub pixel SP1 and the second sub pixel SP2 included in the first pixel PX1.

Likewise, image data DATA provided from the second latch L2 and the fifth latch L5 are image data corresponding to a data signal supplied to one pixel PX, for example, a second pixel PX2 of FIG. 3 and may correspond to a data signal supplied to each of the third sub pixel SP3 and the fourth sub pixel SP4 included in the second pixel PX2.

Likewise, image data DATA provided from the third latch L3 and the sixth latch L6 are image data corresponding to a data signal supplied to one pixel PX, for example, a third pixel PX3 of FIG. 3 and may correspond to a data signal supplied to each of the fifth sub pixel SP5 and the sixth sub pixel SP6 included in the third pixel PX3.

That is, the image data provided from the first latch L1, the image data provided from the third latch L3, and the image data DATA provided from the fifth latch L5 are data signals which are supplied to the first pixel circuit PC1 of one pixel PX, for example, may be image data DATA corresponding to the first data signal Vdata1. Further, the image data provided from the second latch L2, the image data provided from the fourth latch L4, and the image data DATA provided from the sixth latch L6 are data signals which are supplied to the second pixel circuit PC2 of one pixel PX, for example, may be image data DATA corresponding to the second data signal Vdata2.

The switch unit 133 may time-divide the analog type data signal (data voltage) output from the digital analog converting unit 132 based on the source control signal SOE to provide the data signal to the buffer unit 134.

For example, the first switch SW1 may connect the first digital analog converter DAC1 and the first buffer BUF1 in response to the first source control signal SOE1 to provide a data signal obtained by converting image data provided from the first latch L1 into an analog type data signal to the first buffer BUF1. The second switch SW2 may connect the first digital analog converter DAC1 and the first buffer BUF1 in response to the second source control signal SOE2 to provide a data signal obtained by converting image data provided from the fourth latch L4 into an analog type data signal to the first buffer BUF1.

Likewise, the third switch SW3 may connect the second digital analog converter DAC2 and the second buffer BUF2 in response to the first source control signal SOE1 to provide a data signal obtained by converting image data provided from the second latch L2 into an analog type data signal to the second buffer BUF2. The fourth switch SW4 may connect the second digital analog converter DAC2 and the second buffer BUF2 in response to the second source control signal SOE2 to provide a data signal obtained by converting image data provided from the fifth latch L5 into an analog type data signal to the second buffer BUF2.

Likewise, the fifth switch SW5 may connect the third digital analog converter DAC3 and the third buffer BUF3 in response to the first source control signal SOE1 to provide a data signal obtained by converting image data provided from the third latch L3 into an analog type data signal to the third buffer BUF3. The sixth switch SW6 may connect the third digital analog converter DAC3 and the third buffer BUF3 in response to the second source control signal SOE2 to provide a data signal obtained by converting image data provided from the sixth latch L6 into an analog type data signal to the third buffer BUF3.

In the exemplary embodiment, the data driver 130 further may include a multiplexer 135.

The multiplexer 135 may time-divide the data signal output from the buffer unit 134 to n data lines DL based on a MUX signal MUX. To this end, the multiplexer 135 may include n MUX switches. In the meantime, in FIG. 7, six MUX switches MX1 to MX6 among n MUX switches included in the multiplexer 135 are illustrated.

For example, odd-numbered MUX switches, for example, a first MUX switch MX1, a third MUX switch MX3, and a fifth MUX switch MX5 may connect a plurality of buffers, for example, a first buffer BUF1, a second buffer BUF2, and a third buffer BUF3 to odd-numbered data lines, for example, a first data line DL1, a third data line DL3, and a fifth data line DL5, one to one, based on the first MUX signal MUX1.

Further, even-numbered MUX switches, for example, a second MUX switch MX2, a fourth MUX switch MX4, and a sixth MUX switch MX6 may connect a plurality of buffers, for example, a first buffer BUF1, a second buffer BUF2, and a third buffer BUF3 to even-numbered data lines, for example, a second data line DL2, a fourth data line DL4, and a sixth data line DL6, one to one, based on the second MUX signal MUX2.

Accordingly, corresponding data signals may be supplied to the plurality of data lines DL1 to DL6. Here, in a period in which a turn-on level of first MUX signal MUX1 is supplied, a data signal is supplied to an odd-numbered data line so that a data signal corresponding to an image supplied in a first range may be written in the first pixel circuit PC1 included in each pixel PX. Further, in a period in which a turn-on level of second MUX signal MUX2 is supplied, a data signal is supplied to an even-numbered data line so that a data signal corresponding to an image supplied in a second range may be written in the second pixel circuit PC2 included in each pixel PX.

FIG. 8 is a block diagram illustrating an example of a timing controller included in a display device of FIG. 2 according to an exemplary embodiment of the present disclosure.

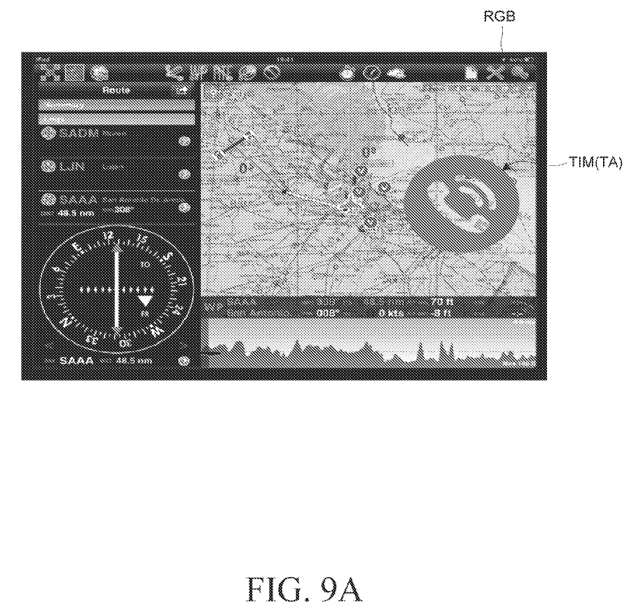

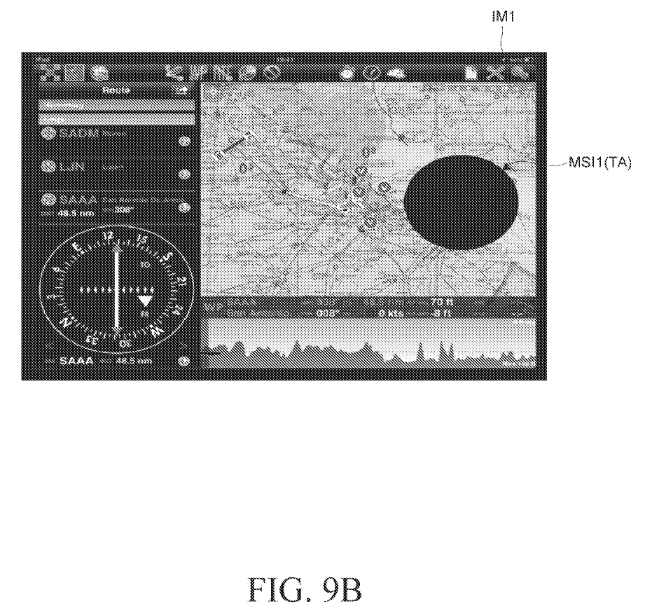

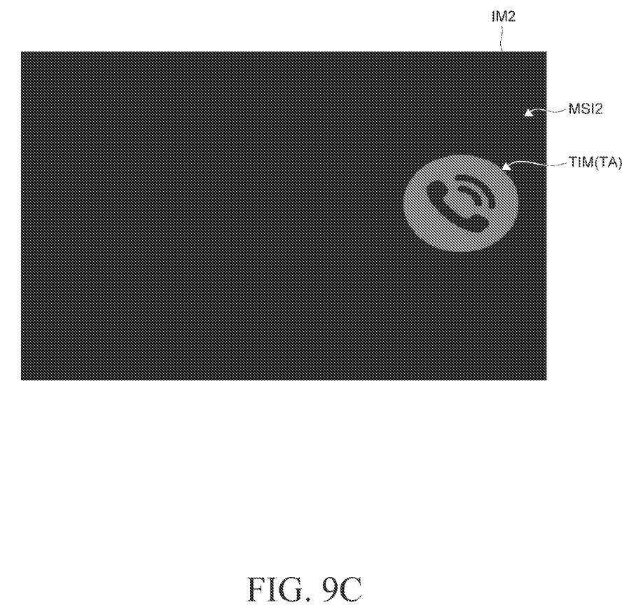

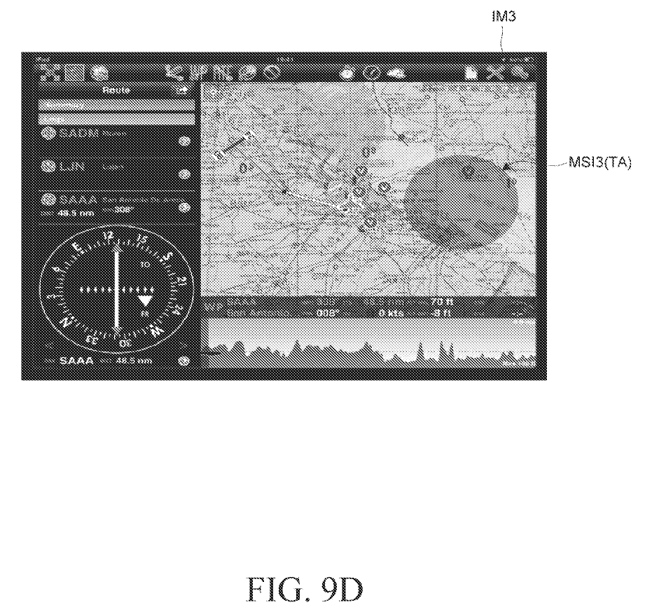

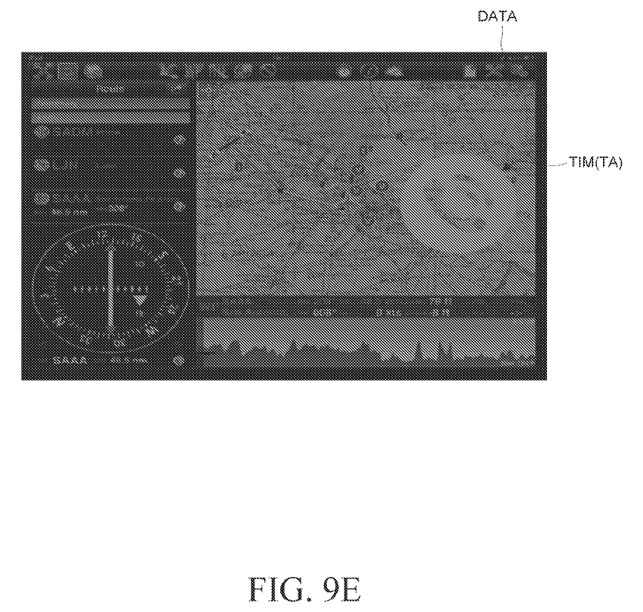

FIGS. 9A to 9E are views for explaining an example of an operation of a timing controller of FIG. 8 according to an exemplary embodiment of the present disclosure.

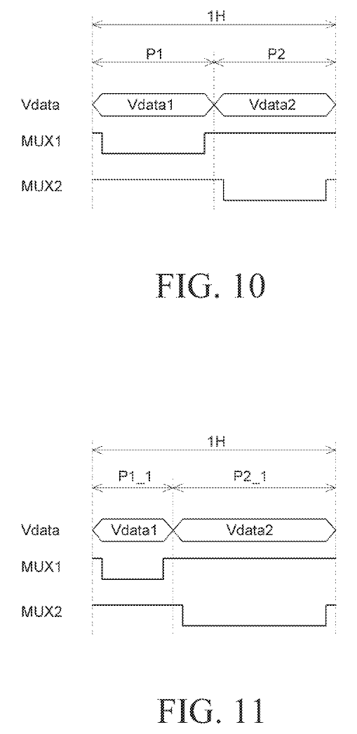

FIG. 10 is a waveform chart for explaining an example of an operation of a MUX signal generating unit included in a timing controller of FIG. 8 according to an exemplary embodiment of the present disclosure.

FIG. 11 is a waveform chart for explaining another example of an operation of a MUX signal generating unit included in a timing controller of FIG. 8 according to an exemplary embodiment of the present disclosure.

Referring to FIG. 8, the timing controller 110 may separate an input image RGB into two images, for example, two images IM1 and IM2 provided in a first range of viewing angle and a second range of viewing angle, and then adjusts a gray scale of at least a partial area, of one of two images IM1 and IM2, for example, the first image IM1, to generate a third image IM3. Further, the timing controller 110 may remap the second image IM2 and the third image IM3 to generate image data DATA corresponding to each of the second image IM2 and the third image IM3. Here, the data signals generated based on the image data DATA corresponding to each of the second image IM2 and the third image IM3 may be supplied to two sub pixels included in one pixel PX, respectively.

To this end, in one exemplary embodiment, the timing controller 110 may include an image separating unit 111 (e.g., a circuit), a grayscale adjusting unit 112 (e.g., a circuit), and an image data generating unit 113 (e.g., a circuit).

The image separating unit 111 may receive a mode signal MODE and an input image RGB, from the outside, for example, a host system.

Here, the mode signal Mode is generated when an event that it is necessary to control a field of view of at least some content included in an image displayed on the display panel 140 which has been described with reference to FIG. 2 is generated to be provided to the timing controller 110, for example, the image separating unit 111.

For example, referring to FIG. 9A together, when among various contents included in the input image RGB, a target image TIM which needs to control a viewing angle is included in a target area TA, the mode signal MODE is generated to be supplied to the timing controller 110. In the meantime, the mode signal MODE may be generated in response to the user input (for example, a touch), but is not limited thereto. Therefore, the mode signal MODE may be automatically generated from the outside (for example, a host system), according to a type of the content included in the image (for example, contents regarding an entertainment function and seat information for a passenger sitting on a front passenger seat).

The image separating unit 111 may generate the first image IM1 and the second image IM2 from the input image RGB in response to the mode signal MODE. For example, the image separating unit 111 may generate a first image IM1 including contents for a remaining part excluding the target area TA in which the target image TIM is disposed, from the input image RGB and a second image IM2 including contents for a part corresponding to the target image TIM.

To be more specific, referring to FIG. 9B together, the image separating unit 111 masks a part of the input image RGB corresponding to the target area TA to generate the first image IM1 including a first masking image MSI1. For example, the image separating unit 111 may adjust a grayscale level of a part of the input image RGB corresponding to the target area TA to a specific level. For example, as illustrated in FIG. 9B, the image separating unit 111 may adjust a grayscale level of a part of the input image RGB corresponding to the target area TA to a black gray scale (for example, a gray scale of 0). In this case, the first masking image MSI1 included in the first image IM1 overlaps the target area TA and may have a black gray scale. However, the grayscale level of a part of the input image RGB corresponding to the target area TA adjusted by the image separating unit 111 is not limited thereto and the grayscale level of the first masking image MSI1 may be a predetermined grayscale level excluding the black gray scale.

Further, referring to FIG. 9C together, the image separating unit 111 masks a remaining part of the input image RGB excluding the target area TA to generate the second image IM2 including a second masking image MSI2. For example, the image separating unit 111 may adjust a grayscale level of a remaining part of the input image RGB excluding the target area TA to a specific level. For example, as illustrated in FIG. 9C, the image separating unit 111 may adjust a grayscale level of a remaining part of the input image RGB excluding the target area TA to a black gray scale (for example, a gray scale of 0). In this case, the second masking image MSI2 included in the second image IM2 does not overlap the target area TA and may have the black gray scale. However, the grayscale level of a part of the input image RGB excluding the target area TA adjusted by the image separating unit 111 is not limited thereto and the grayscale level of the second masking image MSI2 may be a predetermined grayscale level excluding a black gray scale.

The first image IM1 and the second image IM2 generated from the image separating unit 111 may be provided to the grayscale adjusting unit 112.

The grayscale adjusting unit 112 may receive the first image IM1 and the second image IM2 from the image separating unit 111 and may receive masking information MSK from the outside, for example, the host system. Here, the masking information MSK may include position information (coordinate information) and size information of the target image TIM. For example, an area corresponding to the position information and the size information included in the masking information MSK may correspond to the target area TA. In the meantime, as described above, the mode signal MODE and the masking information MSK illustrated in FIG. 8 may be signals included in the input control signal CS which has been described with reference to FIG. 2.

The grayscale adjusting unit 112 may adjust a gray scale of at least one of the first image IM1 and the second image IM2 to generate a third image IM3. For example, the grayscale adjusting unit 112 may adjust a gray scale of at least a partial area of the first image IM1 including the first masking image MSI1 in which a part corresponding to the target area TA in which the target image TIM which is a content which needs to control a viewing angle is disposed is masked.

For example, referring to FIG. 9C together, the grayscale adjusting unit 112 may adjust a grayscale level of an area corresponding to the position information and the size information included in the masking information MSK of the first image IM1, based on position information (coordinate information) and size information of the target image TIM included in the masking information MSK. That is, the grayscale adjusting unit 112 may adjust a grayscale level of the target area TA.

To be more specific, the target area TA which needs to control a viewing angle is separated from the input image RGB as it is to generate image data DATA corresponding to the first image IM1 in which the target area TA is masked and the second image IM2 in which an area excluding the target area TA is masked. When a data signal corresponding to the image data DATA is supplied to the first pixel circuit PC1 and the second pixel circuit PC2 of each pixel PX to display images, an image which is displayed by a data signal corresponding to the first image IM1, for example, an image which is displayed in a wide viewing angle range which is a first viewing angle range and an image which is displayed by a data signal corresponding to the second image IM2, for example, an image which is displayed in a narrow viewing angle range which is a second viewing angle range may be recognized together to a user (for example, a passenger) who watches a display image in a position when the viewing angle is not restricted. Here, in the case of the image which is displayed by the data signal corresponding to the first image IM1, the target area TA is masked so that the black gray scale image is displayed in the target area TA. Therefore, an image corresponding to the target image TIM and an image of the black gray scale overlap in the target area TA, by an image corresponding to the data signal generated based on the first image IM1 and an image corresponding to a data signal generated based on the second image IM2 to be recognized by the user. Here, a display quality may be deteriorated by a difference in a grayscale level of an image corresponding to the target image TIM and a black gray scale. Further, when the image data DATA is generated to provide the contents of a partial area, for example, a target area TA at a narrow viewing angle according to the mode signal MODE, the continuity of the image in the target area TA may be deteriorated to a user who watches the image in a position where the viewing angle is restricted.

Accordingly, the grayscale adjusting unit 112 may adjust a gray scale of the target area TA of the first image IM1, for example, a gray scale of the first masking image MSI1 to generate a third image IM3 including a third masking image MSI3. For example, the grayscale adjusting unit 112 may increase a gray scale of the target area TA of the first image IM1, for example, a grayscale level of the first masking image MSI1. Accordingly, the grayscale level of the third masking image MSI3 may be higher than the grayscale level of the first masking image MSI1.

For example, referring to FIG. 9D together, the grayscale adjusting unit 112 may adjust the grayscale level of the target area TA to a grayscale level which is lower than a grayscale level of the target image TIM which is a content displayed in the target image TA in the first image IM1. For example, the grayscale adjusting unit 112 may generate the third image IM3 including the third masking image MSI3 by adjusting the grayscale level of the target area TA of the first image IM1 to a grayscale level corresponding to an intermediate value of a grayscale level (for example, a black gray scale) of the first masking image MSI1 included in the first image IM1 in the target area TA and a grayscale level of an image excluding the target image TIM from the input image RGB, but is not limited thereto.

Next, referring to FIGS. 8 and 9E together, the image data generating unit 113 may receive the second image IM2 and the third image IM3 generated from the grayscale adjusting unit 112, may remap the second image IM2 and the third image IM3, and may generate image data DATA corresponding to the second image IM2 and the third image IM3.

Here, a data signal corresponding to the image data DATA generated based on the third image IM3, for example, the first data signal Vdata1 is supplied to the first pixel circuit PC1 of each pixel PX so that an image generated by light emitted from the first light emitting diode ED1 of each pixel PX may correspond to the third image IM3. Therefore, an image displayed by the image data DATA which is generated based on the third image IM3 may be displayed in a wide viewing angle range which is the first viewing angle range.

Further, a data signal corresponding to the image data DATA generated based on the second image IM2, for example, the second data signal Vdata2 is supplied to the second pixel circuit PC2 of each pixel PX so that an image generated by light emitted from the second light emitting diode ED2 of each pixel PX may correspond to the second image IM2. Therefore, an image displayed by the image data DATA which is generated based on the second image IM2 may be displayed in a narrow viewing angle range which is the second viewing angle range.

Accordingly, a user (for example, a driver) who watches a display image in a position where the viewing angle is restricted may recognize only a display image corresponding to the third image IM3. Therefore, a field of view for the content corresponding to the target image TIM is restricted and a variation of the grayscale level in the target area TA may have a relatively low value. For example, a difference between a grayscale level of an image of a previous frame, for example, a grayscale level of an image in a frame before an event for restriction of the viewing angle occurs and a grayscale level in the target area TA of the third image IM3 is relatively low. Therefore, the continuity of the image may be ensured to improve the quality of the display image.

Referring to FIG. 8 again, in the exemplary embodiment, the timing controller 110 further may include a MUX signal generating unit 114.

The MUX signal generating unit 114 may generate a MUX signal MUX which has been described with reference to FIG. 7, for example, a first MUX signal MUX1 and a second MUX signal MUX2 based on the mode signal MODE.

In the exemplary embodiment, further referring to FIG. 10, the MUX signal generating unit 114 may generate a MUX signal MUX in which the first MUX signal MUX1 has a turn-on level, for example, a low level pulse in a first period P1 of one horizontal period 1H and the second MUX signal MUX2 has a turn-on level, for example, a low level pulse in a second period P2 excluding the first period P1 of one horizontal period 1H. Here, the first period P1 and the second period P2 may have the same or substantially same width. That is, each of the first period P1 and the second period P2 may be a period corresponding to a half of one horizontal period 1H.

Accordingly, the first data signal Vdata1 corresponding to the image data DATA generated based on the third image IM3 is output to the data line DL, by the turn-on level of first MUX signal MUX1 in the first period P1, to be written in the first pixel circuit PC1 of each pixel PX. The second data signal Vdata2 corresponding to the image data DATA generated based on the second image IM2 is output to the data line DL, by the turn-on level of second MUX signal MUX2 in the second period P2, to be written in the second pixel circuit PC2 of each pixel PX.

However, the exemplary embodiment of the present disclosure is not limited thereto. In one exemplary embodiment, further referring to FIG. 11, a first period P1_1 in which the first MUX signal MUX1 generated by the MUX signal generating unit 114 has a turn-on level and a second period P2_1 in which the second MUX signal MUX2 has a turn-on level may have different widths. For example, the width of the first period P1_1 may be smaller than the width of the second period P2_1. For example, a width of the period in which the first MUX signal MUX1 has a turn-on level may be smaller than a width of the period in which the second MUX signal MUX2 has a turn-on level.

In this case, in an image displayed by light emitted from the first light emitting diode ED1 included in the first pixel circuit PC1, a width of the first MUX signal MUX1 for writing the first data signal Vdata1 is reduced so that in the corresponding image, a data variation of a previous frame and a present frame may be reduced. Accordingly, in order to control a field of view of a content corresponding to the target area TA, for example, a target image TIM, the continuity of the display image is ensured to a user who watches only the display image corresponding to the third image IM3 generated by masking the target area TA and adjusting the gray scale. Therefore, the quality of the display image may be improved.

As described above, the display device 100 according to the exemplary embodiment of the present disclosure separates two images IM1 and IM2 to provide an input image RGB at different viewing angles and then adjusts a gray scale of at least a partial area of one of two images IM1 and IM2 to generate the image data DATA. Accordingly, a continuity of an image which is recognized by a user who watches the image in a position where a viewing angle is restricted may be ensured to improve a quality of the display image.

The exemplary embodiments of the present disclosure can also be described as follows:

According to an aspect of the present disclosure, a display device includes a timing controller which generates image data based on an input image, a data driver which generates a data signal based on the image data and outputs the data signal to a data line and a display panel which includes a pixel connected to the data line, wherein the timing controller generates a first image and a second image based on the input image, generates a third image by adjusting a gray scale of at least a partial area of the first image, and generates image data corresponding to the second image and the third image.

The timing controller may include an image separating unit which generates the first image and the second image from the input image based on the input image and a mode signal, a grayscale adjusting unit which generates the third image by adjusting a gray scale of at least partial area of the first image, based on the first image, the second image, and masking information and an image data generating unit which generates the image data based on the second image and the third image.

The image separating unit may generate the first image including a first masking image which overlaps the target area by masking a target area of the input image in which a target image is disposed and generates the second image including a second masking image which overlaps the remaining area by masking a remaining area of the input image excluding the target area.

Each the first masking image and the second masking image may have a black grayscale level.

The grayscale adjusting unit may adjust a gray scale of the first masking image included in the first image to generate the third image including a third masking image.

A grayscale level of the third masking image may be higher than a grayscale level of the first masking image.

The grayscale adjusting unit may generate the third masking image having a grayscale level corresponding to an intermediate value of a grayscale level of the first masking image included in the first image and a grayscale level of an image excluding the target image from the input image.

The masking information may include size information and position information of the target area.

The data driver may generate a first data signal based on image data corresponding to the second image, generates a second data signal based on image data corresponding to the third image, and outputs the first data signal and the second data signal to the data line.

The timing controller may further include a MUX signal generating unit which generates a first MUX signal for controlling a timing when the first data signal is output and a second MUX signal for controlling a timing when the second data signal is output.

A width of a period in which the first MUX signal has a turn-on level may be smaller than a width of a period in which the second MUX signal has a turn-on level.

The pixels may include a first pixel circuit including a first light emitting diode, a first optical member which refracts light from the first light emitting diode, a second pixel circuit including a second light emitting diode which emits the same color light as the first light emitting diode and a second optical member which refracts light from the second light emitting diode and has a shape different from that of the first optical member.

A first data signal corresponding to image data generated based on the third image may be supplied to the first pixel circuit and a second data signal corresponding to image data generated based on the second image may be supplied to the second pixel circuit.

The first optical member and the second optical member may have different shapes.

The first optical member may have a viewing angle having a first value and the second optical member may have a viewing angle having a second value which is smaller than the first value.

According to another aspect of the present disclosure, a display device includes a timing controller which generates a second image and a third image based on an input image and generates image data based on the second image and the third image, a data driver which generates a first data signal based on image data corresponding to the second image, generates a second data signal based on image data corresponding to the third image, and outputs the first data signal and the second data signal to the data line and a display panel which includes a pixel connected to the data line, wherein the timing controller generates a first MUX signal for controlling a timing when the first data signal is output and a second MUX signal for controlling a timing when the second data signal is output and a width of a period in which the first MUX signal has a turn-on level is smaller than a width of a period in which the second MUX signal has a turn-on level.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A display device, comprising:
a timing controller configured to generate image data based on an input image;
a data driver configured to generate a data signal based on the image data and output the data signal to a data line; and
a display panel that includes a pixel connected to the data line,
wherein the timing controller is further configured to generate a first image and a second image based on the input image, generate a third image by adjusting a gray scale of at least a partial area of the first image, and generate image data corresponding to each of the second image and the third image.

2. The display device according to claim 1, wherein the timing controller includes:
an image separating unit configured to generate the first image and the second image from the input image based on the input image and a mode signal;
a grayscale adjusting unit configured to generate the third image by adjusting a gray scale of the at least the partial area of the first image based on the first image, the second image, and masking information; and
an image data generating unit configured to generate the image data based on the second image and the third image.

3. The display device according to claim 2, wherein the image separating unit generates the first image including a first masking image that overlaps a target area by masking the target area of the input image in which a target image is disposed and generates the second image including a second masking image which overlaps a remaining area by masking the remaining area of the input image excluding the target area.

4. The display device according to claim 3, wherein each the first masking image and the second masking image have a black grayscale level.

5. The display device according to claim 3, wherein the grayscale adjusting unit generates the third image including a third masking image by adjusting a gray scale of the first masking image included in the first image.

6. The display device according to claim 5, wherein a grayscale level of the third masking image is higher than a grayscale level of the first masking image.

7. The display device according to claim 5, wherein the grayscale adjusting unit generates the third masking image having a grayscale level corresponding to an intermediate value of a grayscale level of the first masking image included in the first image and a grayscale level of an image excluding the target image from the input image.

8. The display device according to claim 3, wherein the masking information includes size information and position information of the target area.

9. The display device according to claim 2, wherein the data driver is configured to generate a first data signal based on image data corresponding to the second image, generate a second data signal based on image data corresponding to the third image, and output the first data signal and the second data signal to the data line.

10. The display device according to claim 9, wherein the timing controller further includes:
a multiplexer signal generating unit configured to generate a first multiplexer signal that controls a timing when the first data signal is output and a second multiplexer signal that controls a timing when the second data signal is output.

11. The display device according to claim 10, wherein a width of a period in which the first multiplexer signal has a turn-on level is less than a width of a period in which the second multiplexer signal has a turn-on level.

12. The display device according to claim 1, wherein the pixel includes:
a first pixel circuit including a first light emitting diode;
a first optical member that refracts light from the first light emitting diode;
a second pixel circuit including a second light emitting diode, the second light emitting diode emitting a same color light as the first light emitting diode; and
a second optical member that refracts light from the second light emitting diode, the second optical member having a shape that is different from a shape of the first optical member.

13. The display device according to claim 12, wherein a first data signal corresponding to image data generated based on the third image is supplied to the first pixel circuit and a second data signal corresponding to image data generated based on the second image is supplied to the second pixel circuit.

14. The display device according to claim 13, wherein the first optical member and the second optical member have different shapes.

15. The display device according to claim 13, wherein the first optical member has a first viewing angle having a first value and the second optical member has a second viewing angle having a second value that is less than the first value.

16. A display device, comprising:
a timing controller configured to generate a first image and a second image based on an input image and generate image data based on the first image and the second image;
a data driver configured to generate a first data signal based on image data corresponding to the first image, generate a second data signal based on image data corresponding to the second image, and output the first data signal and the second data signal to a data line; and
a display panel that includes a pixel connected to the data line,
wherein the timing controller is further configured to generate a first multiplexer signal that controls a timing when the first data signal is output and a second multiplexer signal that controls a timing when the second data signal is output, and
wherein a width of a period in which the first multiplexer signal has a turn-on level is less than a width of a period in which the second multiplexer signal has a turn-on level.
